(19) United States
(12) Patent Application Publication
(10) Pub. No.: US 2026/0314581 A1
(43) Pub. Date: Oct. 15, 2026

(54) EXTENDIBLE AND RETRACTABLE OUTRIGGER ASSEMBLY

(71) Applicants: Victor Maxwell Roswell Lee, Wilmington, NC (US); Andrew Maxwell Roswell Lee, Wilmington, NC (US)

(72) Inventors: Victor Maxwell Roswell Lee, Wilmington, NC (US); Andrew Maxwell Roswell Lee, Wilmington, NC (US)

(21) Appl. No.: 19/179,821

(22) Filed: Apr. 15, 2025

(51) Int. Cl. A01K 91/08

(52) U.S. Cl. CPC A01K 91/08

(57) ABSTRACT

The invention is an improved system that can be used to quickly and easily retract and extend an outrigger. In the system, the outrigger line travels in a loop through outrigger eyelets and through a pulley or ring held off the boat gunwale. Advantageously, the system allows a double rigged and/or triple rigged outrigger to both retract and extend by pulling on a loop of line. Double and triple rigged outriggers allow users to run two or three outrigger lines per outrigger, respectively. Simultaneously, the rigging of the outrigger system stows away in a retracted orientation.

### FIELD OF THE INVENTION

The presently disclosed subject matter is directed to an improved outrigger assembly configured to both extend and retract poles from the deck of a boat simply and easily.

### BACKGROUND OF THE INVENTION

Outrigger structures are used on boats and other aquatic vessels to extend the lateral reach of the vessel for various purposes. Specifically, outriggers are commonly attached to the sides of a fishing boat and extend beyond the boat hull to widen the fishing trolling area and accommodate multiple rigging lines. Outriggers also provide stability to the fishing boat and allow users to easily troll for surface fish. Further, the use of outriggers provides a way to effectively increase the spacing of the bait, as well as to add additional bait lines without increasing the possibility of entangling the lines when landing a fish.

An outrigger is basically a long pole having a proximal end attached to the vessel and a distal end that can be moved from a stowage position adjacent to the vessel (e.g., a retracted position) to a deployed position away from the vessel to a trolling position (e.g., an extended position). In current outrigger systems, one or more positioning lines are drawn along the length of the outrigger pole and release clips secured to the positioning line are used to attach the fishing pole line to a desired location.

Conventional outrigger structures are often provided with several fixed eye bolts. A plurality of outrigger cords/rigging lines are passed through the eye bolts and a pulley assembly is positioned at a fixed point on the boat. Each outrigger cord/rigging line forms a displaceable and closed loop about the pulley assembly and one or more supporting eye bolts, and each carries a release clip onto which a fishing line may be secured for movement along the outrigger structure with the outrigger cord/rigging. A user may retract or advance the release clip by pulling the corresponding outrigger cord/rigging in a desired direction through its loop. When a fishing line is baited, the user pulls one outrigger cord/rigging to draw an associated release clip within reach, loads the clip with a baited fishing line that has been cast, then pulls the outrigger cord/rigging in a reverse direction to return the loaded clip to a deployment position on the outrigger structure. The process is repeated for each baited fishing line that has been cast out from the boat. When a bite occurs (fish on) or when a fishing line encounters sufficient tension, the clip releases so that the line returns to form a direct line between its feeding point (i.e., fishing rod) for active user control. When a fish strikes the bait, the release clip disengages the fishing line from the positioning line, and the fisherman is free to reel in the fish without interference. The proper placement of the outrigger pole and fishing line increase the chances of fish being drawn to the bait.

Typically, outriggers are deployed only when fishing or trolling at relatively slow speeds (such as five knots or less). For this reason, outriggers must be retractable to allow for normal cruising and docking and to ensure that the vessel will not interfere with marine navigation. During storage, outriggers are generally retracted within the side walls of the vessel. While retracted, the outriggers will not obstruct or interfere with other vessels or any other fixed objects in the path of the vessel. During deployment, the outrigger is swung laterally outward to an extended position for fishing purposes.

However, current outriggers suffer from significant drawbacks. For example, it typically is a complicated and slow process to both extend and retract an outrigger assembly. In addition, with current telescoping outriggers, the fisherman must stand on the gunwale or the leading post/seat to reach poles to extend or retract them, which can be dangerous on a boat. For example, a fisherman can easily slip and fall to the deck or even overboard while reaching for the poles. Further, in strong winds, the pressure makes it very difficult (or even impossible) to swing the outriggers into the fishing position and then retract them.

It would therefore be desirable to provide an improved assembly capable of quickly and easily securing and deploying the outriggers. The disclosed assembly enables the a user to quickly and easily release the outriggers from a stowed position to a deployed position where the outriggers are positioned away from the vessel. Likewise, it is also desirable to provide the vessel with an outrigger assembly that can also quickly, safely, and easily stow and secure the outriggers on board the vessel when they are not in use.

### SUMMARY

In some embodiments, the presently disclosed subject matter is directed to a retracting and extending outrigger system. Particularly, the system comprises a base section including a first end and an opposed second end; a tip section including a first end comprising a spike defined as a tapered tip, an opposed second end comprising an arm, and two rigging line roller guides; a middle section including a first end and an opposed second end, the middle section positioned between the base and tip sections; an upper plug that cooperates, the upper plug comprising an upper arm positioned at a first end of the upper plug, a foundation positioned at an opposed second end of the upper plug, an internal passageway that spans a length the upper plug, an internal roller guide in contact with the upper plug internal passageway, and a plurality of apertures; a base plug comprising an upper arm positioned at a first end and a foundation positioned at an opposed end of the base plug, an internal passageway, a plurality of roller guides, and a plurality of apertures; an upper clamp comprising an internal passageway, a large roller guide, a small roller guide, a central roller, and a series of apertures, wherein the upper plug upper arm is housed within the interior passageway of the upper clamp; a middle plug comprising an upper arm positioned at a first end of the middle plug and a foundation positioned at a second end of the middle plug, an internal passageway that spans a length of the middle plug, a plurality of apertures, and a plurality of rollers; a lower clamp comprising an internal passageway that passes through a length of the lower clamp between a lower clamp first end and opposed second end, a pair of first and second roller guides, and a series of apertures, wherein the upper arm of the middle plug is housed within the interior passageway of the lower clamp and the middle plug foundation extends from the second end of the lower clamp; a first tubing section with a first end positioned over the spike arm and an op-posed second end positioned over the upper plug upper arm within the interior of the upper clamp; a second tubing section with a first end and an opposed second end, wherein the first end of the second tubing section is positioned over the foundation of the upper plug and the second end of the second tubing section is positioned over the middle plug upper arm within the interior of the upper clamp; a third tubing section with a first end and an opposed second end, wherein the first end of the third tubing section is positioned over the middle plug foundation and the second end of the third tubing section is positioned over the base plug upper arm and the base plug foundation extends outward from the second end of the third tubing section; a first outrigger pole; a middle outrigger pole; a base outrigger pole; wherein the system has an extended orientation and a collapsed orientation.

In some embodiments, the outrigger has a length of about 6.5-8.5 feet in the collapsed orientation.

In some embodiments, the plugs, clamps, and spike have a circular cross-sectional shape.

In some embodiments, the first pole, middle pole, and base pole have a length of about 5-15 feet.

In some embodiments, the first pole has an inner diameter of about 1-9 inches, the middle pole has an inner diameter of about 1.5-9.5 inches, and the base pole has an inner diameter of about 2-10 inches.

In some embodiments, the first pole has an outer diameter of about 1-10 inches, the middle pole has an outer diameter of about 2-10 inches, and the base pole has an outer diameter of about 2.5-10.5 inches.

In some embodiments, the system further includes a loop of outrigger line for use in the retracted orientation and the extended orientation.

In some embodiments, the outrigger line enters the system at the lower clamp, passes through the apertures of the lower plug to the base plug, extends through the central passageway of the base plug, and extends upwards through the central passageway of the middle plug, the lower clamp, the upper plug, and the upper clamp.

In some embodiments, the outrigger line includes a retracting portion that extends through the central passageway of each element of the system.

In some embodiments, the system apertures are aligned to allow the outrigger line to pass through during the extended and retracted orientations.

In some embodiments, the outrigger line is wound and unwound within the interior of the base, middle, and tip sections.

In some embodiments, the presently disclosed subject matter is directed to a method of extending the disclosed outrigger system. Particularly, the method comprises passing the outrigger line through the upper plug apertures into the upper clamp apertures; turning the outrigger line such that it turns and travels back through a different upper plug aperture back down to the middle plug; fastening an end of the loop at the bottom of the upper plug; moving the outrigger line through the upper plug towards the upper clamp, in between the tip section and the middle section; inverting the outrigger line passing through the passageway in the upper plug; passing the outrigger line to the middle plug; inverting the outrigger line such that it is between the middle and base sections; passing the outrigger line through the lower clamp; exiting the outrigger line from the system.

In some embodiments, the presently disclosed subject matter is directed to a method of retracting the disclosed outrigger system. Particularly, the method comprises passing the outrigger line through the lower clamp; passing the outrigger line in between the base and middle sections to the middle plug; at the middle plug, the outrigger line continues to the base plug wherein it moves through the base section; passing the outrigger line through the central passageway of the middle plug and the middle section through the central passageway of the upper plug and tip; passing the outrigger line through the tip spike where the line is fastened with a knot to fix the end of the loop.

### BRIEF DESCRIPTION OF THE DRAWINGS

FIG. 1a is an expanded perspective view of an outrigger system in accordance with some embodiments of the presently disclosed subject matter.

FIG. 1b is an assembled outrigger system in accordance with some embodiments of the presently disclosed subject matter.

FIG. 2a is a side plan view of a system spike in accordance with some embodiments of the presently disclosed subject matter.

FIG. 2b is a top view of a system spike in accordance with some embodiments of the presently disclosed subject matter.

FIG. 2c is a bottom view of a system spike in accordance with some embodiments of the presently disclosed subject matter.

FIG. 3a is a side plan view of a system upper plug in accordance with some embodiments of the presently disclosed subject matter.

FIG. 3b is a perspective view of a system upper plug in accordance with some embodiments of the presently disclosed subject matter.

FIG. 3c is a top view of a system upper plug in accordance with some embodiments of the presently disclosed subject matter.

FIG. 3d is a bottom view of a system upper plug in accordance with some embodiments of the presently disclosed subject matter.

FIG. 4a is a front plan view of the system upper clamp section in accordance with some embodiments of the presently disclosed subject matter.

FIG. 4b is a rear plan view of the system upper clamp section in accordance with some embodiments of the presently disclosed subject matter.

FIG. 4c is a top view of the system upper clamp section in accordance with some embodiments of the presently disclosed subject matter.

FIG. 4d is a bottom view of the system upper clamp section in accordance with some embodiments of the presently disclosed subject matter.

FIG. 4e is a side plan view of an upper plug and upper clamp in accordance with some embodiments of the presently disclosed subject matter.

FIG. 4f is a side plan view of an upper plug and upper clamp cooperating with first and second tubing sections in accordance with some embodiments of the presently disclosed subject matter.

FIG. 4g is a side plan view of an assembled upper plug, upper clamp, and first and second tubing sections in accordance with some embodiments of the presently disclosed subject matter.

FIG. 5a is a front view of the system middle plug section in accordance with some embodiments of the presently disclosed subject matter.

FIG. 5b is a perspective view of the system middle plug section in accordance with some embodiments of the presently disclosed subject matter.

FIG. 5c is a top view of the system middle plug section in accordance with some embodiments of the presently disclosed subject matter.

FIG. 5d is a bottom view of the system middle plug section in accordance with some embodiments of the presently disclosed subject matter.

FIG. 6a is a front view of the system lower clamp section in accordance with some embodiments of the presently disclosed subject matter.

FIG. 6b is a rear view of the system lower clamp section in accordance with some embodiments of the presently disclosed subject matter.

FIG. 6c is a top view of the system lower clamp section in accordance with some embodiments of the presently disclosed subject matter.

FIG. 6d is a bottom view of the system lower clamp section in accordance with some embodiments of the presently disclosed subject matter.

FIG. 6e is a side plan view of a middle plug and lower clamp in accordance with some embodiments of the presently disclosed subject matter.

FIG. 6f is a side plan view of a middle plug and lower clamp cooperating with second and third tubing sections in accordance with some embodiments of the presently disclosed subject matter.

FIG. 6g is a side plan view of an assembled middle plug, lower clamp, and second and third tubing sections in accordance with some embodiments of the presently disclosed subject matter.

FIG. 7a is a front view of the system base plug section in accordance with some embodiments of the presently disclosed subject matter.

FIG. 7b is a perspective view of the system base plug section in accordance with some embodiments of the presently disclosed subject matter.

FIG. 7c is a top view of the system base plug section in accordance with some embodiments of the presently disclosed subject matter.

FIG. 7d is a bottom view of the system base plug section in accordance with some embodiments of the presently disclosed subject matter.

FIG. 7e is a side plan view of a base plug and third tubing section in accordance with some embodiments of the presently disclosed subject matter.

FIG. 7f is a side plan view of an assembled base plug in accordance with some embodiments of the presently disclosed subject matter.

FIG. 8a is a perspective view of a system base section in accordance with some embodiments of the presently disclosed subject matter.

FIG. 8b is a perspective view of a system middle section in accordance with some embodiments of the presently disclosed subject matter.

FIG. 8c is a perspective view of a system top section in accordance with some embodiments of the presently disclosed subject matter.

FIG. 9a is a cross-sectional view of a system base section in accordance with some embodiments of the presently disclosed subject matter.

FIG. 9b is a cross-sectional view of a system middle section in accordance with some embodiments of the presently disclosed subject matter.

FIG. 9c is a cross-sectional view of a system top section in accordance with some embodiments of the presently disclosed subject matter.

FIGS. 10a-10f are expanded views showing the system rigging in accordance with some embodiments of the presently disclosed subject matter.

FIGS. 10g-10i are perspective views showing the system rigging in accordance with some embodiments of the presently disclosed subject matter.

FIG. 10j is a side plan view illustrating system rigging in accordance with some embodiments of the presently disclosed subject matter.

FIGS. 11a and 11b are cross-sectional views of the system sections illustrating rigging in accordance with some embodiments of the presently disclosed subject matter.

FIG. 12a is a rear view of a system illustrating alignment of the system apertures in accordance with some embodiments of the presently disclosed subject matter.

FIGS. 12b and 12c are perspective views illustrating alignment of the system in accordance with some embodiments of the presently disclosed subject matter.

FIG. 13 is a side view of the system assembled on a boat in accordance with some embodiments of the presently disclosed subject matter.

### DETAILED DESCRIPTION OF THE INVENTION

For the purpose of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e., at least one) of the grammatical object of the article. By way of example, “an element” means at least one element and can include more than one element. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods. Thus, the term “about” is used to provide flexibility to a numerical range endpoint by providing that a given value may be “slightly above” or “slightly below” the endpoint without affecting the desired result.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

All methods described herein can be performed in any suitable order unless otherwise indicated herein or otherwise clearly contradicted by context. The use of any and all examples, or exemplary language (e.g., “such as”) provided herein, is intended merely to better illuminate the invention, and does not pose a limitation on the scope of the invention unless otherwise claimed. No language in the specification should be construed as indicating any unclaimed element as essential to the practice of the invention.

Unless otherwise defined, all technical terms used herein have the same meaning as commonly understood by one of ordinary skill in the art to which this disclosure belongs.

The presently disclosed subject matter is directed to an improved system that can be used to quickly and easily retract and extend an outrigger as desired by a user. As noted above, the outriggers are long poles that extend from a boat to spread out lines, allowing fishermen to cover more area and catch more fish. In the disclosed system, the outrigger line travels in a loop through outrigger eyelets and through a pulley or ring held off the boat gunwale. As set forth in detail below, the disclosed system allows a double rigged and/or triple rigged outrigger to both retract and extend by pulling on a loop of line. Double and triple rigged outriggers allow users to run two or three outrigger lines per outrigger, respectively. Simultaneously, the rigging of the outrigger system stows away in a retracted orientation.

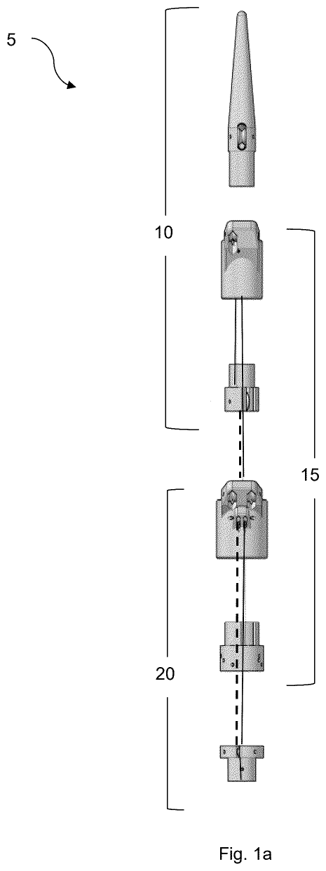

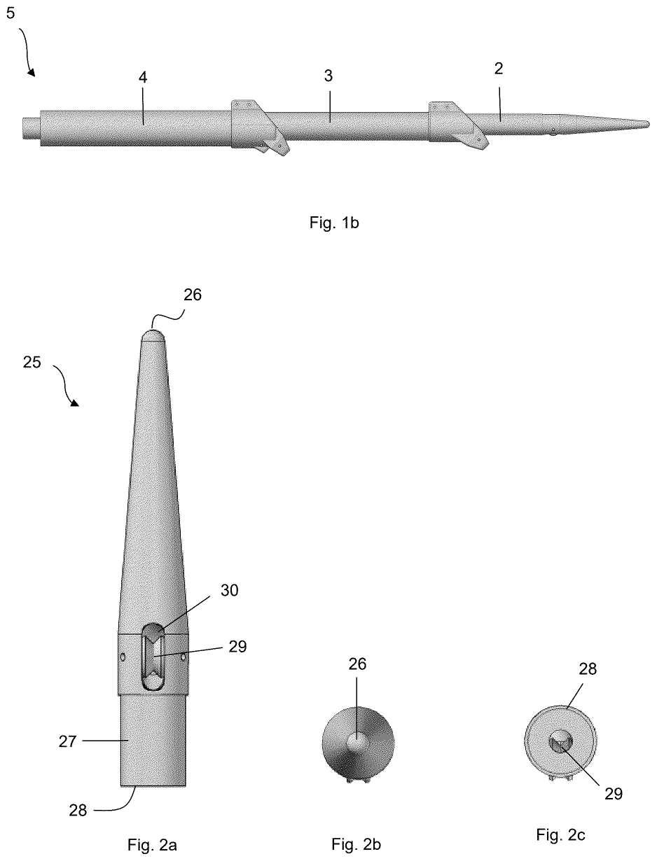

As illustrated in FIGS. 1a and 1b, the retractable and extendable double rigged outrigger system 5 comprises at least three connected sections, although additional sections can be added (e.g., a plurality of middle sections). A “double rigged” system allows for two baits to be deployed off each outrigger pole, such as a long bait and a short bait on each side of the boat. The length of the outrigger and the number of sections can be adjusted as needed to be suitable for the particular size and type of fish being sought. As illustrated, the system includes tip section 10, middle section 15, and base section 20 positioned adjacent to the boat using any conventional mechanism (e.g., bolts, fasteners, welding). The system can be used to quickly and easily retract and extend an outrigger using first, second, and third tubing sections 2, 3, and 4. An “extended” outrigger is fully lengthened for maximum width during use. A “retracted” outrigger is collapsed to reduce the outrigger in size to about 6.5 to 8.5 feet (e.g., at least/no more than about 3. 3.5, 4, 4.5, 5, 5.5, 6, 6.5, 7, 7.5, 8, 8.5, 9, 9.5, 10, 10.5, 11, 11.5, or 12 feet in some embodiments). As discussed in detail below, the system plugs and clamps cooperate to direct and control the winding and unwinding of line as well as the retraction and extension of the outrigger.

As noted above, the tip section includes a spike configured at one end of the system. As illustrated in FIGS. 2a-2c, spike 25 includes tapered tip 26 positioned at a first end of the spike, and arm 27 that is positioned at second end 28 of the spike. The spike also includes roller guide 29 (e.g., rollers or wheels) to direct and control the winding of two rigging lines within the interior of the system, as discussed below. First tubing section 5 fits over arm 27 when the system is fully assembled.

The term “roller guides” refers to components that include small rollers that rigging line passes over. The rollers reduce friction, allowing the line to move smoothly during telescoping and advancing of the outrigger. Thus, the roller guides direct the external and internal rigging lines during telescoping and expanding of the outrigger, as well as maintain line integrity. In some embodiments, each roller guide includes a grooved wheel that functions to guide a portion of rigging line through an adjacent opening. The rigging line can be directed through the center of the wheel (e.g., within a wheel groove). The wheel is positioned within housing 30 that protects the wheel and rigging line from damage, as well as ensures that the line remains on the wheel.

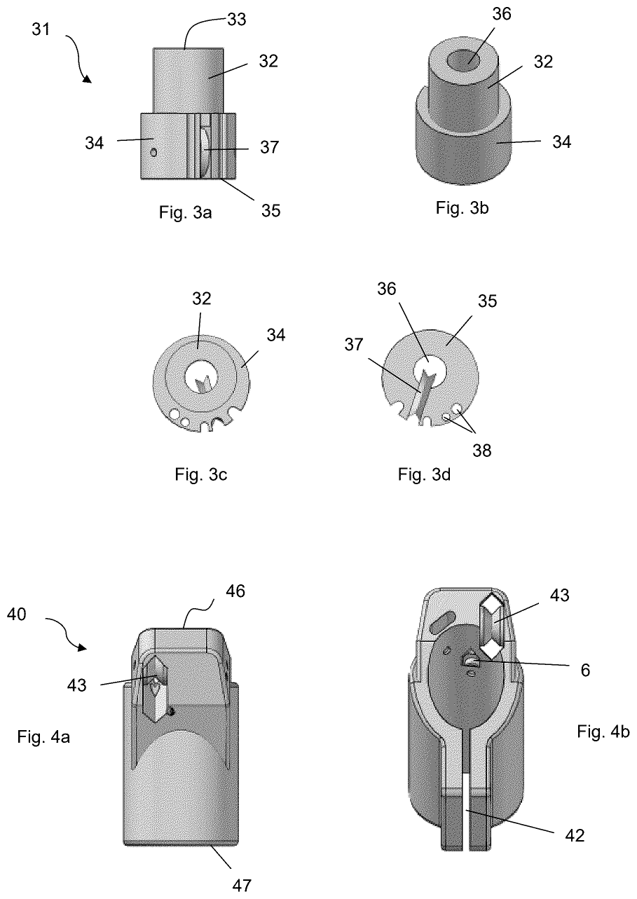

The first section also includes an upper plug that cooperates with upper clamp 40, discussed below. FIGS. 3a-3d illustrate one embodiment of upper plug 31 comprising upper arm 32 positioned at a first end 33 and foundation 34 positioned at the opposed end 35. The upper plug also includes internal passageway 36 that spans the length of the device. The system passageways can be configured as channels that span the interior of an element from a first end to an opposed second end. The upper plug also includes internal roller guide 37 in contact with the internal passageway. Further, the upper plug comprises a plurality of apertures 38 as shown.

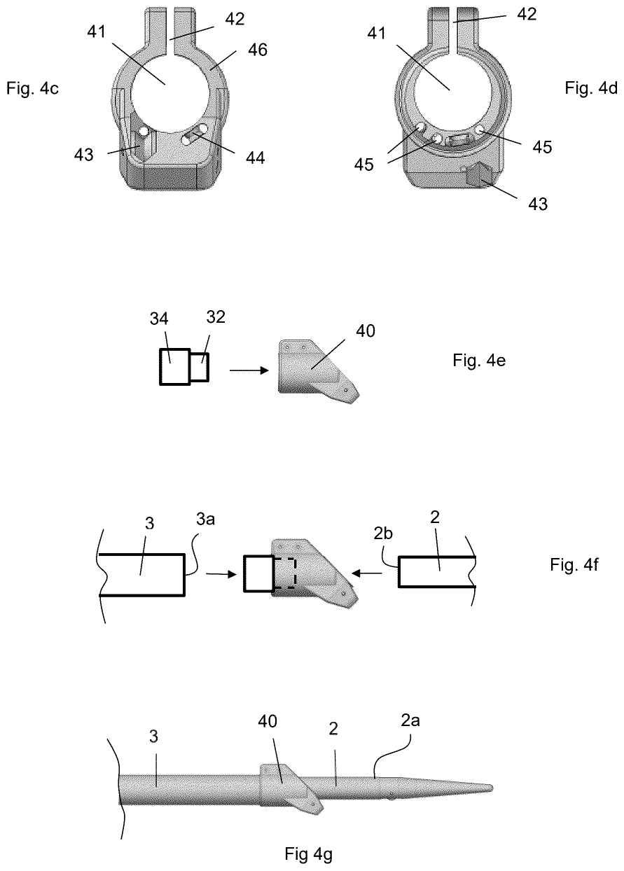

FIGS. 4a-4d illustrate one embodiment of upper clamp 40 comprising internal passageway 41 that passes through the length of the device (e.g., from first end 46 to second end 47). The passageway is in fluid communication with opening 42. The upper clamp also includes large and small roller guides 43, 44 and center roller 6 that route the line during extending and collapsing of the outrigger system. The upper clamp also includes a series of apertures 45 sized and shaped for the passage of line, as described below.

In use, the upper plug is housed within the interior of upper clamp 40 and allows for attachment of the first and second tubing sections 2 and 3. Specifically, upper arm 32 is housed within the interior of the upper clamp, as shown in FIG. 4e. The second end 2b of first tubing section 2 then fits over upper arm 32 within the interior of the upper clamp. The first end 3a of the second section of tubing 3 is then positioned over foundation 34 of the upper plug, as shown in FIGS. 4f and 4g. The first end 2a of the first section 2 fits over arm 27 of the spike, as also shown in FIG. 4g.

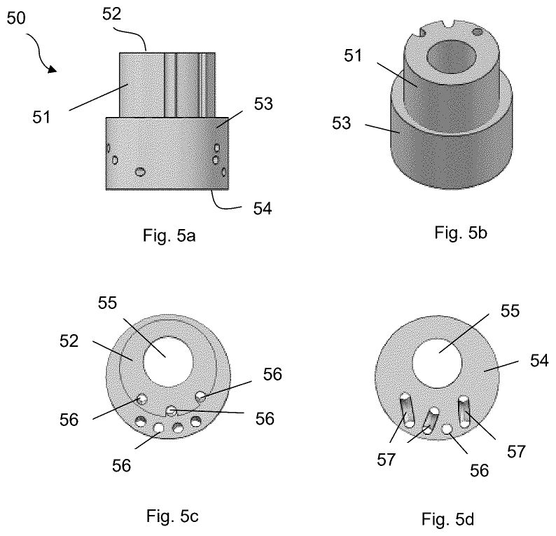

As noted above, the system also includes a middle plug that is positioned within lower clamp 60. FIGS. 5a-5d illustrate one embodiment of middle plug 50 comprising upper arm 51 positioned at first end 52 and foundation 53 positioned at the opposed end 54. The upper plug also includes internal passageway 55 that spans the length of the device. The upper plug also includes a plurality of apertures 56 configured to allow line to pass through and a plurality of rollers guides 57, as described in detail below.

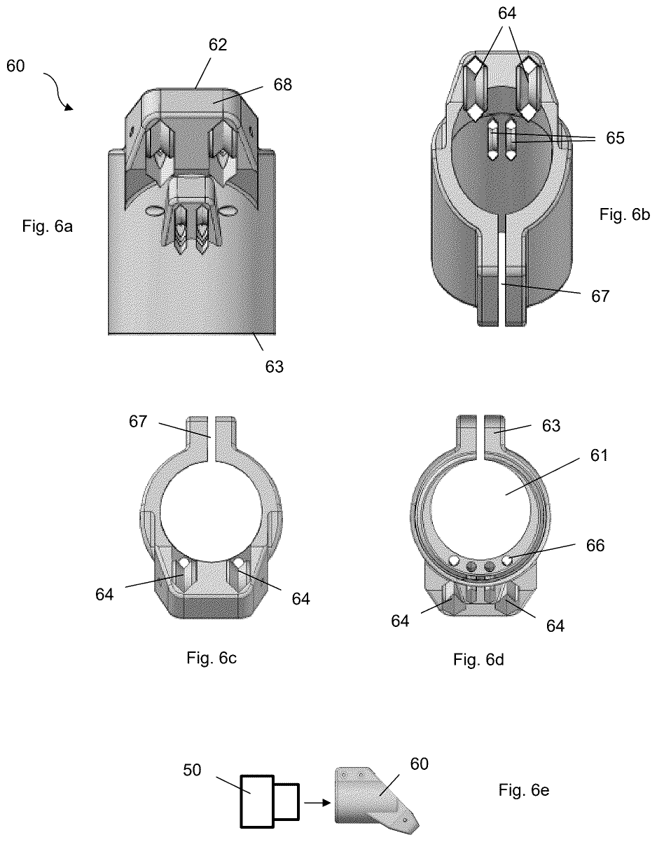

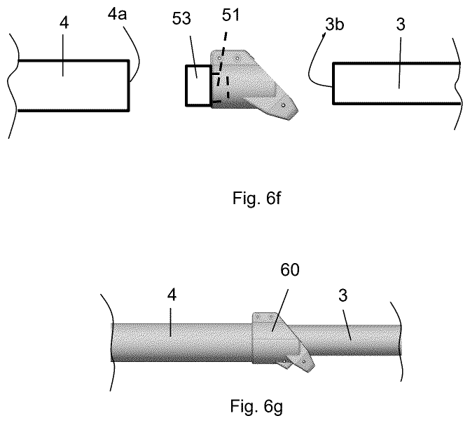

FIGS. 6a-6d illustrate one embodiment of lower clamp 60 comprising internal passageway 61 that passes through the length of the device, from first end 62 to opposed second end 63. The internal passageway is in fluid communication with opening 67 that spans the length of the lower clamp. The lower clamp also includes a pair of first and second roller guides 64, 65 and a series of apertures 66 sized and shaped for the passage of line, as described below. As shown, the first pair of rollers are positioned within housing 68 to protect the rollers during use.

In use, the middle plug is housed within the interior of lower clamp 60 and allows for attachment of the second and third tubing sections 3 and 4. Specifically, upper arm 51 is housed within the interior of the lower clamp, as shown in FIG. 6e. The middle plug is configured such that upper arm 51 has a diameter that allows it to be positioned within the interior passageway of the lower clamp, while foundation 53 has a diameter greater than the diameter of the interior passageway and thus extends from the second end of the lower clamp. The second end 3b of second tubing section 3 then fits over upper arm 51 within the interior of the upper clamp. The first end 4a of the third section of tubing 4 is then positioned over foundation 53 of the middle plug, as shown in FIGS. 6f and 6g. The first end 3a of the first section 3 fits over foundation 34 of the upper plug, as noted above.

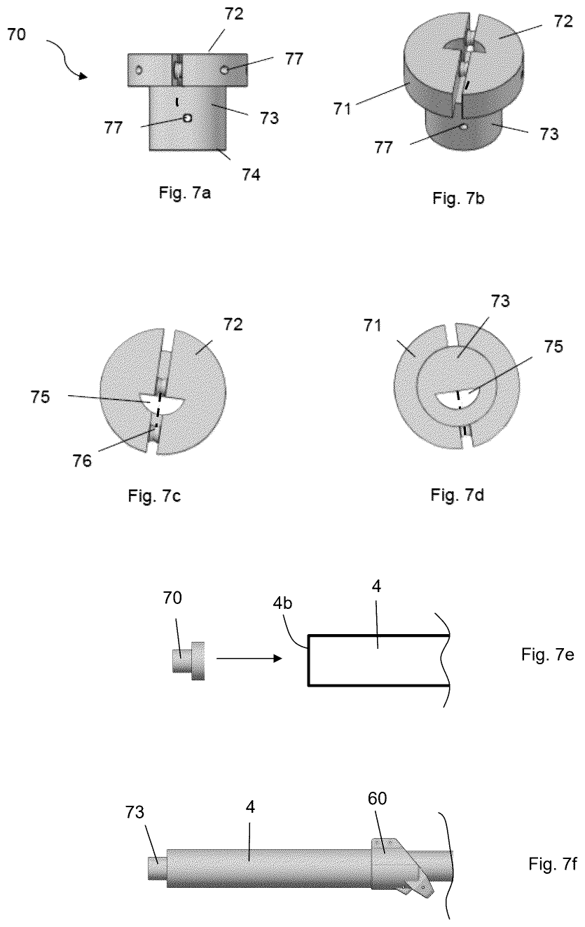

FIGS. 7a-7d illustrate one embodiment of base plug 70 comprising upper arm 71 positioned at a first end 72 and foundation 73 positioned at the opposed end 74. The base plug also includes internal passageway 75 that spans the length of the element. The passageway is used for drainage of water so can have any suitable shape or size. The base also includes a plurality of roller guides 76 and associated apertures configured to allow line to pass through, as described in detail below.

In use, the base plug cooperates with second end 4b of third tubing section 4. As shown in FIG. 7e, upper arm 71 of the base plug is positioned within the second end of the third section 4. Foundation 73 extends outward from the second end of the third section, as shown in FIG. 7f.

As shown, the plugs, clamps, and spike can be configured with a circular cross-sectional shape. However, it should be appreciated that the cross-sectional shapes of the various system elements are not limited, and any shape can be used (e.g., oval, square, rectangular, hexagonal, octagonal, pentagonal, and the like).

In addition to the spike, plugs, and clamps, system 5 also includes first outrigger pole 2, middle outrigger pole 3, and base outrigger pole 4 configured to reduce the outrigger in size to about 6.5 to 8.5 feet (e.g., at least/no more than about 3. 3.5, 4, 4.5, 5, 5.5, 6, 6.5, 7, 7.5, 8, 8.5, 9, 9.5, 10, 10.5, 11, 11.5, or 12 feet) in a collapsed orientation (e.g., at least/no more than about 3, 4, 5, 6, 7, 8, 9, or 10 feet). The system therefore can include more than three pole, such as a plurality of middle outrigger poles).

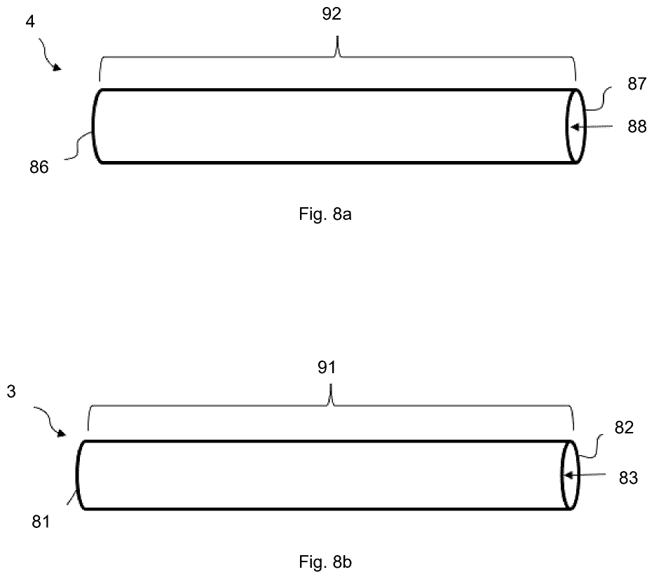

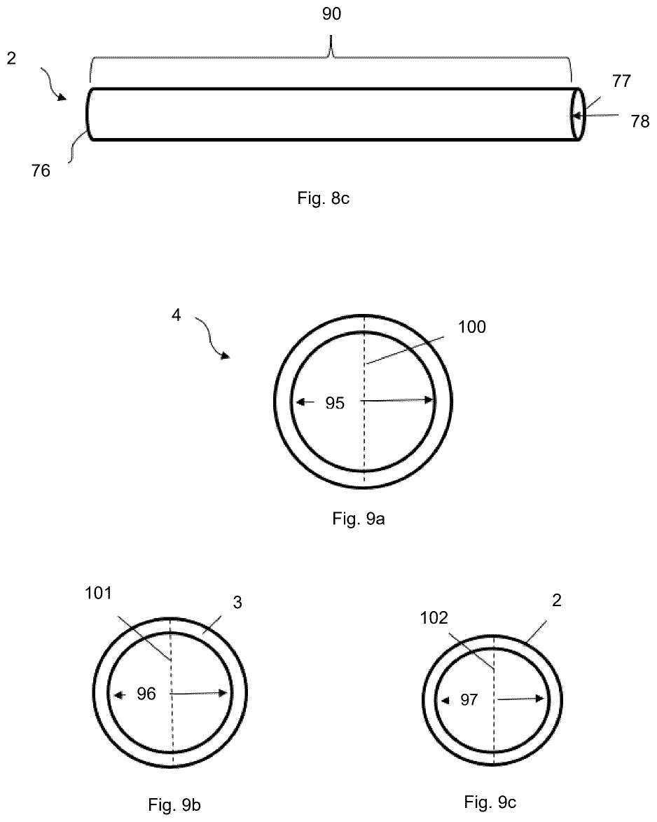

As illustrated in FIGS. 8a-8c, the base outrigger pole 4 includes first end 86 attached to the boat using any conventional mechanism (e.g., bolts, fasteners, welding) and opposed second end 87. Similarly, second (e.g., middle) outrigger pole 3 includes first and second ends 81, 82. First (e.g., top) outrigger pole 2 includes first end 76 and opposed second end 77. The three sections are configured as hollow tubes, each with internal passageway 78, 83, 88.

Those skilled in the art will recognize that while only three outrigger poles are described, telescoping outriggers may have any desired number of extendable poles. For example, the system can include 2, 3, 4, or more

The length of the outrigger and the number of sections can be adjusted as needed to be suitable for the particular size and type of fish being sought.

As shown, the base, middle, and top sections can be configured with a circular cross-sectional shape. However, it should be appreciated that the cross-sectional shape of poles 2, 3, and 4 is not limited and any shape can be used (e.g., oval, square, rectangular, hexagonal, octagonal, pentagonal, and the like).

Poles 2, 3, and 4 can have any suitable lengths 90, 91, and 92, respectively, such as about 5-15 feet (e.g., at least/no more than about 5, 6, 7, 8, 9, 10, 11, 12, 13, 14, or 15 feet). The term “length” refers to the longest horizontal distance between two ends of an element (e.g., between first and second ends 86, 87 of the base pole). However, the presently disclosed subject matter is not limited, and the outrigger poles can be configured with a length that is larger or smaller than the range given above.

In some embodiments, the length of the base pole, middle pole, and top pole can be about the same length (e.g., about 5-15 feet). Thus, the system can be configured as an 18 foot outrigger with three 6 feet long poles in some embodiments. In other embodiments, a 20 foot outrigger can be configured with three 7 foot long poles or a 22 foot outrigger can be configured with three 7.5 foot long poles. In still other embodiments, a 24 foot outrigger can be configured with three 8 foot long poles. It should therefore be appreciated that any combination of lengths of the base, middle, and top poles can be used in an outrigger system.

Thus, the presently disclosed subject matter is not limited and one or more of poles 2, 3, and/or 4 can have a length that is different from one or more other poles. For example, the length of a pole can differ from at least one other pole by about 5-30%. The system can be configured as a 32 foot outrigger with a base pole with a length of 14 feet, a middle pole with a length of 10 feet, and a top pole with a length of 8 feet in some embodiments. It should be appreciated that the lengths of poles 2, 3, and 4 are not limited and can be configured in a variety of lengths.

Each outrigger pole also includes an inner diameter of about 1-10 inches as shown in FIGS. 9a-9c. The term “inner diameter” refers to the largest dimension of an element, measured within the interior of the element, in a direction perpendicular to its axis of elongation. Thus, the base pole inner diameter 95 can be at least/no more than about 2-10 inches (e.g., at least/no more than about 2, 2.5, 3, 3.5, 4, 4.5, 5, 5.5, 6, 6.5, 7, 7.5, 8, 8.5, 9, 9.5, or 10 inches). Inner diameter 96 of the middle pole can be about 1.5-9.5 inches (e.g., at least/no more than about 1.5, 2, 2.5, 3, 3.5, 4, 4.5, 5, 5.5, 6, 6.5, 7, 7.5, 8, 8.5, 9, or 9.5 inches). Inner diameter 97 of the top pole can be about 1-9 inches (e.g., at least/no more than about 1, 1.5, 2, 2.5, 3, 3.5, 4, 4.5, 5, 5.5, 6, 6.5, 7, 7.5, 8, 8.5, or 9 inches). It should be appreciated that the inner diameters of the system poles are not limited to the ranges given above.

Each pole also includes an outer diameter of about 1.5-15 inches. The term “outer diameter” refers to the longest point measured from an outermost wall to an opposed outermost wall. Thus, the base pole outer diameter 100 can be at least/no more than about 2.5-10.5 inches (e.g., at least/no more than about 2.5, 3, 3.5, 4, 4.5, 5, 5.5, 6, 6.5, 7, 7.5, 8, 8.5, 9, 9.5, 10, or 10.5 inches). Outer diameter 101 of the middle pole can be about 2-10 inches (e.g., at least/no more than about 2, 2.5, 3, 3.5, 4, 4.5, 5, 5.5, 6, 6.5, 7, 7.5, 8, 8.5, 9, 9.5 or 10 inches). Outer diameter 102 of the top pole can be about 1-10 inches (e.g., at least/no more than about 1, 1.5, 2, 2.5, 3, 3.5, 4, 4.5, 5, 5.5, 6, 6.5, 7, 7.5, 8, 8.5, 9, 9.5, or 10 inches). It should be appreciated that the outer diameters of the system poles are not limited to the ranges given above.

To allow the outrigger system to telescope, the inner diameter of the base pole is configured to be larger than the outer diameter of the middle pole (e.g., allowing the middle pole to be housed within the interior passageway of the base pole. Similarly, the inner diameter of the middle pole is configured to be larger than the outer diameter of the top pole to allow the top pole to be housed within the interior of the middle pole.

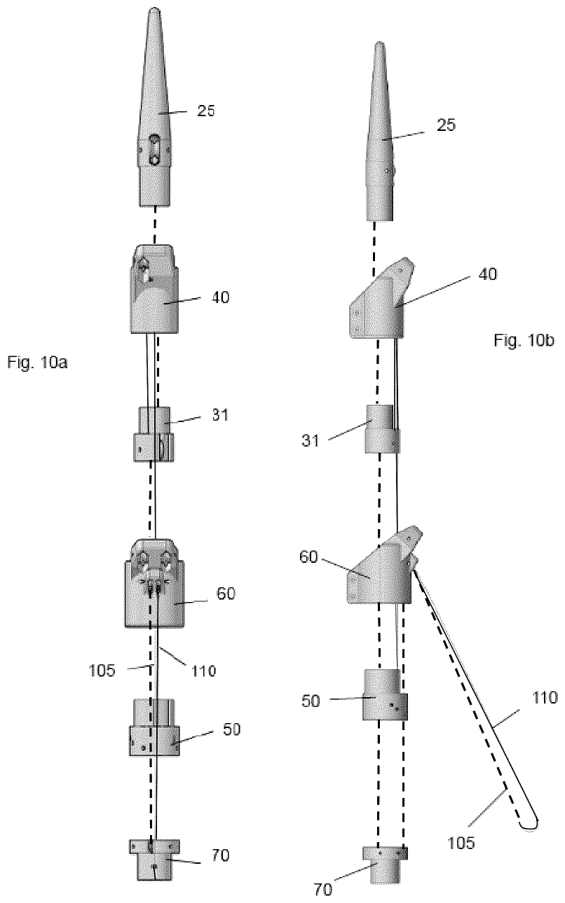

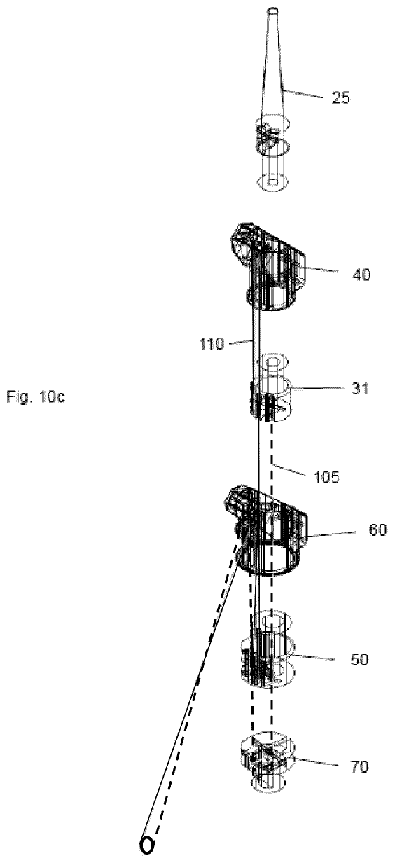

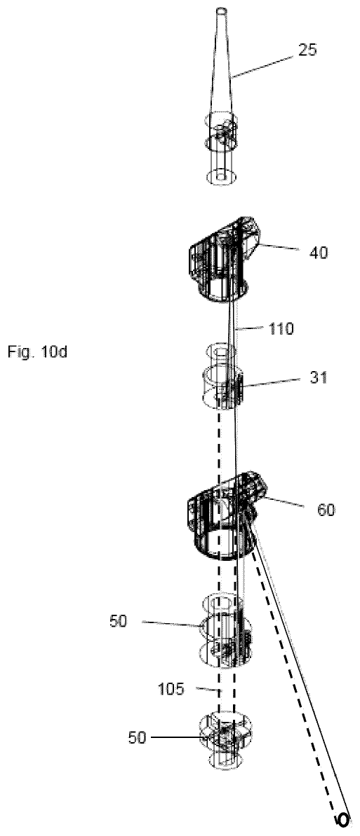

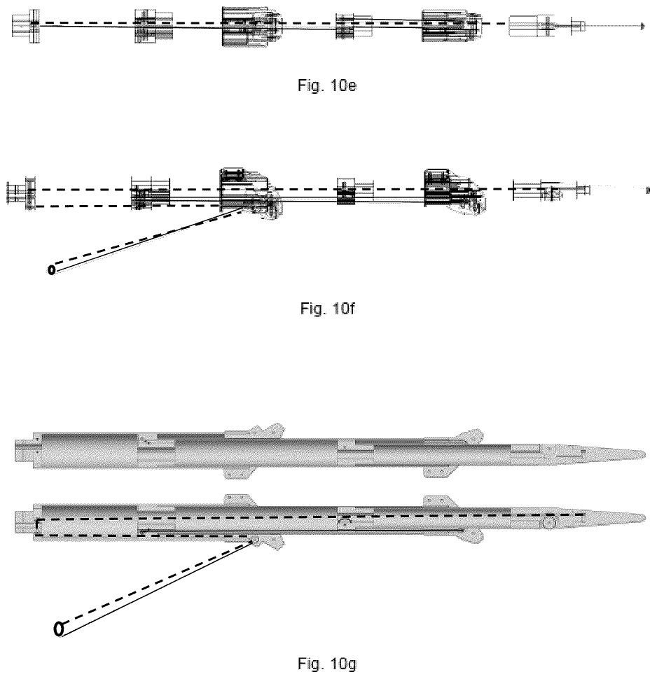

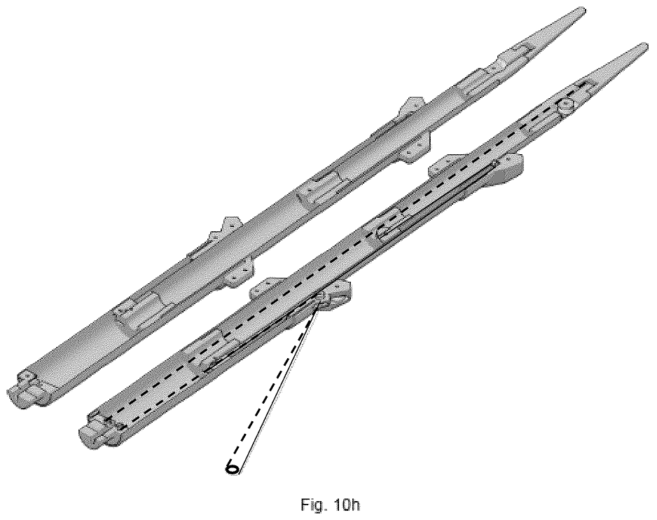

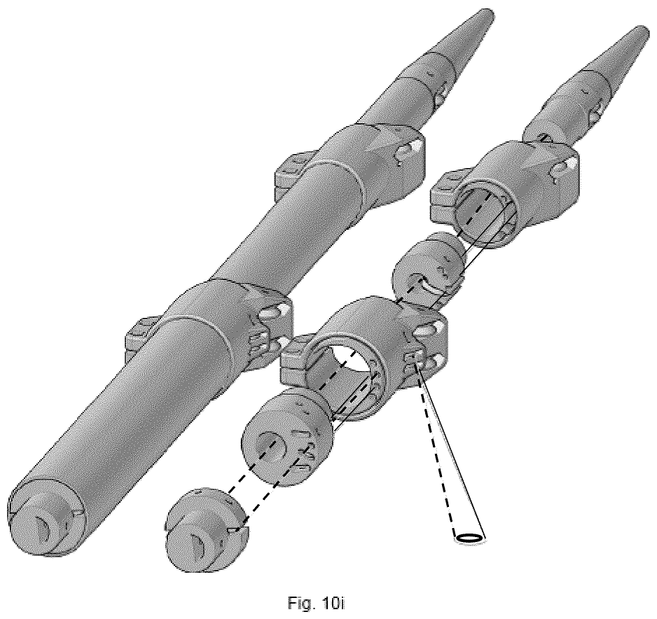

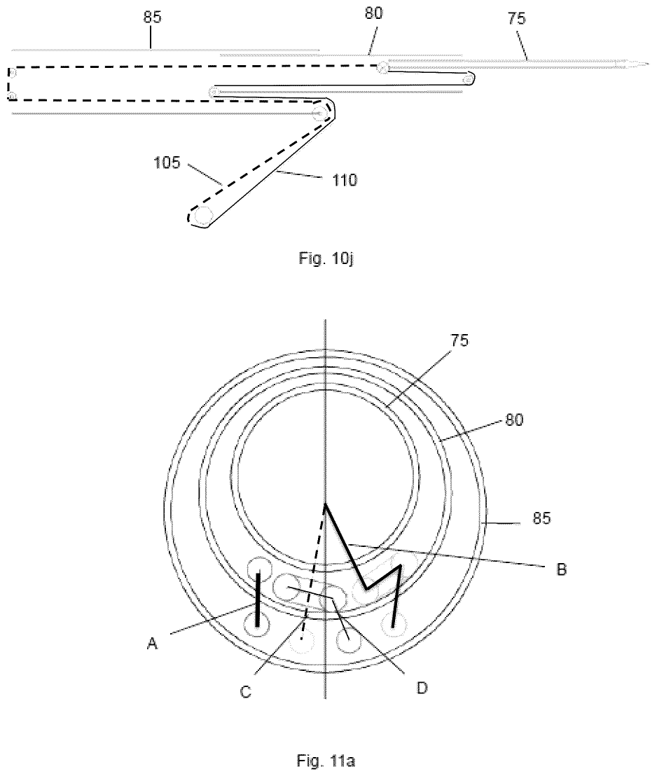

FIGS. 10a-10j illustrate the passage of a loop of line through system 5. As shown, the dashed line is a short outrigger line for retracting 105. The solid line 110 is for extending the same (dashed) line. As shown by the dashed line, the outrigger line enters system 5 at the lower clamp as passes through the apertures of the lower plug to the base plug. At the base plug, the dashed line extends through the central passageway and extends upwards through the central passageway of the lower plug, the lower clamp, and the upper plug.

The retracting part of the loop goes through the central passageway of each element of the system (e.g., the poles 2, 3, and 4, as well as the clamps and plugs). To function correctly, the end of the retract side of the loop is attached to the top section assembly (e.g., the upper plug, upper pole 2 or the spike). In this way, the user will be able to adjust the loop length without having to cut, splice, or tie line together. This is an important feature because there is not enough room for a knot or splice to travel through the lower clamp passageway.

The solid line is for extending the outrigger. As shown, at the upper plug, the solid line passes through the upper plug apertures into the upper clamp apertures where it turns and travels back through a different upper plug aperture back down to the lower plug. This end of the loop is fastened with a stop knot at the bottom of the Upper Plug. The line then moves through the plug up towards the upper clamp, in between the tip section and the middle section. Once at the upper clamp it U-turns on the center roller. Moving back between the tip and middle section, it passes through a passageway in the upper plug. The line continues down to the middle plug. At the middle plug, it U-turns on a roller. The line is now between the middle and base sections moving up to the lower clamp. At the lower clamp, it turns on a roller and will exit the outrigger and head towards a halyard roller. As is known in the art, a halyard roller is a line used to hoist an item on a boat.

From the halyard roller, the function will be for retracting. It will go back to the lower clamp, turn on a different lower clamp roller, moving down in between the base section and the middle section. At the middle plug, it passes through it, continuing to the base plug. At the base plug, it turns on two rollers before moving up through the base section, moving through the center of the middle plug and middle section, through the center of the upper plug and tip section before reaching the spike. At the spike, it can be fastened with a stop knot to fix this end of the loop.

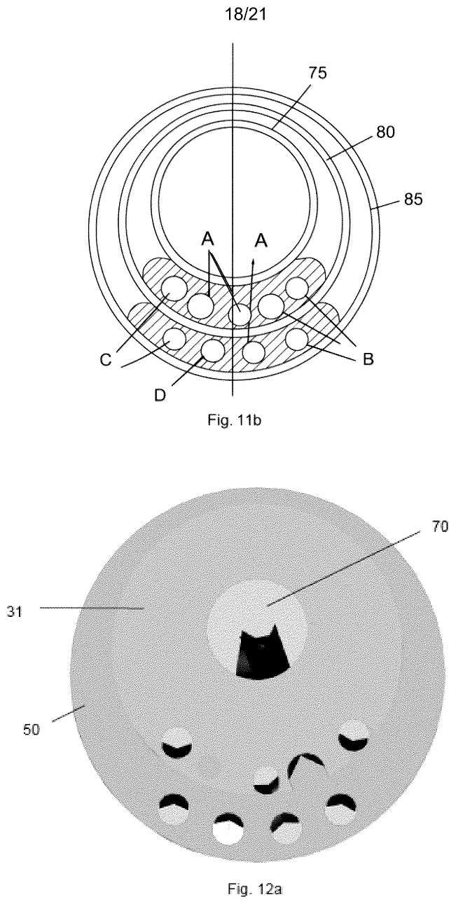

FIGS. 11a and 11b illustrate a cross-sectional view of the system. As illustrated, line A is the short outrigger line that comes out of the pole at the end of the middle pole. Line B is the long outrigger line that comes out at the tip of the outrigger at the end of the base pole. Lines C and D, respectively are part of the same loop, (line D is the extend path, line C is the retract path). Within the interior of the system, there is minimal space. Tubes are pushed to one side to make a crescent shaped opening, the arc created changes as the system approaches the center. Due to the friction of having the line make so many turns, the rollers and apertures are aligned as shown.

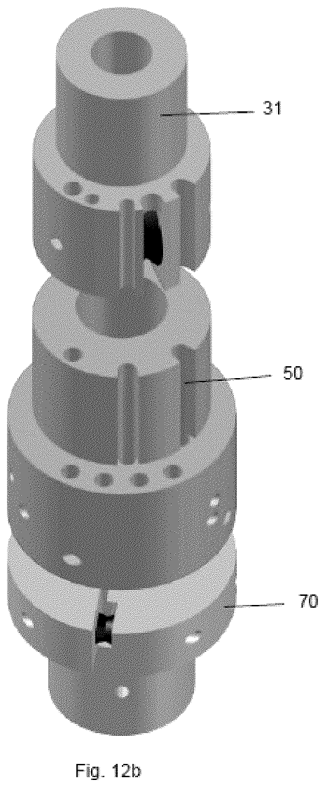

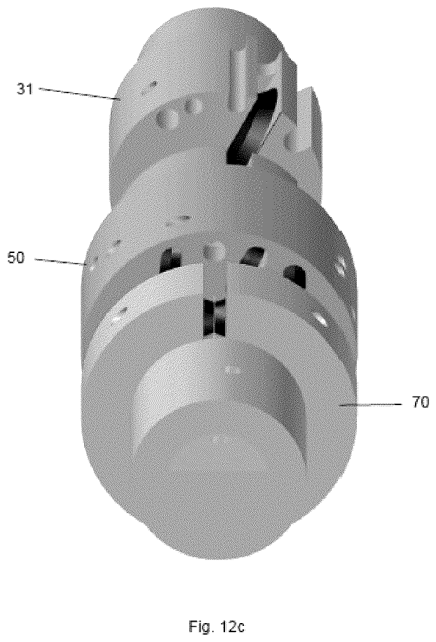

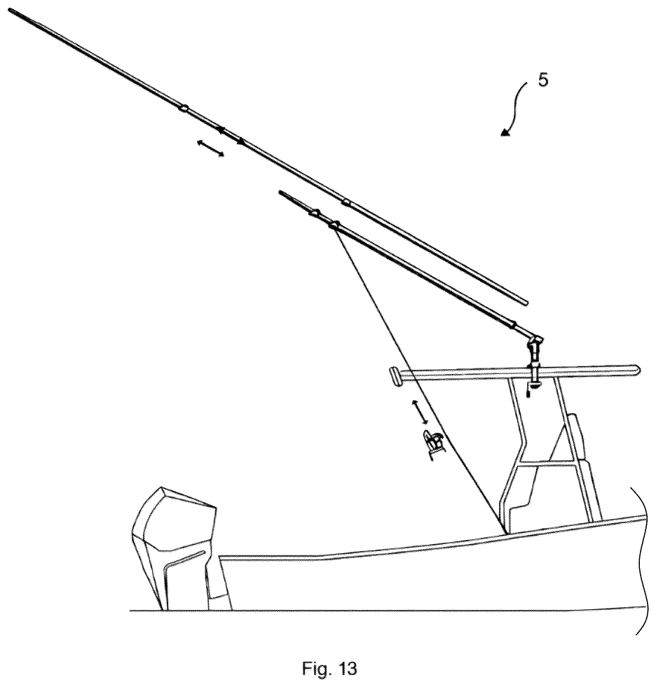

The alignment is further shown in FIGS. 12a-12c. As illustrated, the system apertures are aligned, allowing line to pass throughout the system during extraction and retention.

The disclosed outrigger system includes many benefits over prior art outrigger systems. Specifically, system 5 provides added convenience for the user, allowing for quick and easy extending and retracting of an outrigger.

The disclosed system can be easily installed and is easy to use, without requiring extensive training.

In addition, during strong winds it is very difficult to swing conventional outriggers into the fishing position. However, the disclosed system allows a user to extend the pole from the deck of the boat and put the outriggers into the fishing position in a retracted orientation and then extend them for use, as shown in FIG. 13.

System 5 allows for the rapid telescoping and extending of outriggers with associated rigging (e.g., rigging lines) wound and unwound within the interior of the base, middle, and spike sections. As a result, the rigging is kept neatly stored when not in use, avoiding tangled lines.

System 5 is aesthetically pleasing, providing for a cleaner look without excess rigging pooled on the boat deck.

The fishing application described herein is for illustrative purposes only. To this end, system 5 can be used with any type of telescoping elements, such as (but not limited to) flagpoles.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A retracting and extending outrigger system comprising:
a base section including a first end, an interior, and an opposed second end;
a tip section including a first end comprising a spike defined as a tapered tip, an opposed second end comprising an arm, an interior, and two rigging line roller guides;
a middle section including a first end, an interior, and an opposed second end, the middle section positioned between the base and tip sections;
an upper plug, the upper plug comprising an upper arm positioned at a first end of the upper plug, a foundation positioned at an opposed second end of the upper plug, an interior passageway that spans a length the upper plug, an interior roller guide in contact with the upper plug interior passageway, and a plurality of apertures;
a base plug comprising an upper arm positioned at a first end and a foundation positioned at an opposed end of the base plug, an interior passageway, a plurality of roller guides, and a plurality of apertures;
an upper clamp comprising an interior passageway, a large roller guide, a small roller guide, a center roller, and a series of apertures, wherein the upper plug upper arm is housed within the interior passageway of the upper clamp;
a middle plug comprising an upper arm positioned at a first end of the middle plug and a foundation positioned at a second end of the middle plug, an interior passageway that spans a length of the middle plug, a plurality of apertures, and a plurality of rollers;
a lower clamp comprising an interior passageway that passes through a length of the lower clamp between a lower clamp first end and opposed second end, a pair of first and second roller guides, and a series of apertures, wherein the upper arm of the middle plug is housed within the interior passageway of the lower clamp and the middle plug foundation extends from the second end of the lower clamp;
a first tubing section with a first end positioned over the spike arm and an opposed second end positioned over the upper plug upper arm within the interior passageway of the upper clamp;
a second tubing section with a first end and an opposed second end, wherein the first end of the second tubing section is positioned over the foundation of the upper plug and the second end of the second tubing section is positioned over the middle plug upper arm within the interior passageway of the upper clamp
a third tubing section with a first end and an opposed second end, wherein the first end of the third tubing section is positioned over the middle plug foundation and the second end of the third tubing section is positioned over the base plug upper arm and the base plug foundation extends outward from the second end of the third tubing section;
wherein the system has an extended orientation and a collapsed orientation.

2. The outrigger system of claim 1, wherein the outrigger has a length of about 6.5-8.5 feet in the collapsed orientation.

3. The outrigger system of claim 1, wherein the plugs, clamps, and spike have a circular cross-sectional shape.

4. The outrigger system of claim 1, wherein the first tubing section, second tubing section, and third tubing section each have a length of about 5-15 feet.

5. The outrigger system of claim 1, wherein the first tubing section has an inner diameter of about 1-9 inches, the second tubing section has an inner diameter of about 1.5-9.5 inches, and the third tubing section has an inner diameter of about 2-10 inches.

6. The outrigger system of claim 1, wherein the first tubing section has an outer diameter of about 1-10 inches, the second tubing section has an outer diameter of about 2-10 inches, and the third tubing section has an outer diameter of about 2.5-10.5 inches.

7. The outrigger system of claim 1, further comprising a loop of outrigger line for use in the retracted orientation and the extended orientation.

8. The outrigger system of claim 7, wherein the outrigger line enters the system at the lower clamp, passes through the apertures of the lower plug to the base plug, extends through the central passageway of the base plug, and extends upwards through the central passageway of the middle plug, the lower clamp, the upper plug, and the upper clamp.

9. The outrigger system of claim 7, wherein the outrigger line includes a retracting portion that extends through the central passageway of each element of the system.

10. The outrigger system of claim 1, wherein the apertures of the upper plug, upper clamp, middle plug, lower clamp, and base plug are aligned to allow the outrigger line to pass through during the extended and retracted orientations.

11. The outrigger system of claim 1, wherein the outrigger line is wound and unwound within the interior of the base, middle, and tip sections.

12. A method of extending the outrigger system of claim 1, the method comprising:
passing the outrigger line through the upper plug apertures into the upper clamp apertures;
turning the outrigger line such that it turns and travels back through a different upper plug aperture back down to the middle plug;
fastening an end of the loop at the bottom of the upper plug;
moving the outrigger line through the upper plug towards the upper clamp, in between the tip section and the middle section;
inverting the outrigger line passing through the passageway in the upper plug;
passing the outrigger line to the middle plug;
inverting the outrigger line such that it is between the middle and base sections;
passing the outrigger line through the lower clamp;
exiting the outrigger line from the system.

13. The method of claim 12, wherein the first tubing section, second tubing section, and third tubing section each have a length of about 5-15 feet.

14. The method of claim 12, wherein the first tubing section has an inner diameter of about 1-9 inches, the second tubing section has an inner diameter of about 1.5-9.5 inches, and the third tubing section has an inner diameter of about 2-10 inches.

15. The method of claim 12, wherein the first tubing section has an outer diameter of about 1-10 inches, the second tubing section has an outer diameter of about 2-10 inches, and the third tubing section has an outer diameter of about 2.5-10.5 inches.

16. A method of retracting the outrigger system of claim 1, the method comprising
passing the outrigger line through the lower clamp;
passing the outrigger line in between the base and middle sections to the middle plug;
at the middle plug, the outrigger line continues to the base plug wherein it moves through the base section;
passing the outrigger line through the central passageway of the middle plug and the middle section through the central passageway of the upper plug and tip;
passing the outrigger line through the tip spike where the line is fastened with a knot to fix the end of the loop.

17. The method of claim 16, wherein the outrigger has a length of about 6.5-8.5 feet in the collapsed orientation.

18. The method of claim 16, wherein the first tubing section, the second tubing section, and the third tubing section each have a length of about 5-15 feet.

19. The method of claim 16, wherein the first tubing section has an inner diameter of about 1-9 inches, the second tubing section has an inner diameter of about 1.5-9.5 inches, and the third tubing section has an inner diameter of about 2-10 inches.

20. The method of claim 16, wherein the first tubing section has an outer diameter of about 1-10 inches, the second tubing section has an outer diameter of about 2-10 inches, and the third tubing section has an outer diameter of about 2.5-10.5 inches.
